(19) United States
(12) Patent Application Publication
(10) Pub. No.: US 2010/0026168 A1
(43) Pub. Date: Feb. 4, 2010

(54) Hole Transport Material

(75) Inventors: Kuo-Huang Hsieh, Taipei City (TW); Man-Kit Leung, Taipei City (TW); Wen-Chang Chen, Taipei City (TW); Cheng-Hsiu Ku, Taipei City (TW); Chih-Yu Chen, Taipei City (TW); Cheng-Dar Liu, Taipei City (TW); Ching-Nan Chuang, Taipei City (TW); Yu-Shan Cheng, Taipei City (TW)

Correspondence Address: WPAT, PC;INTELLECTUAL PROPERTY ATTORNEYS, 7225 BEVERLY ST., ANNANDALE, VA, 22003, US

(73) Assignee: National Taiwan University, Taipei City (TW)

(21) Appl. No.: 12/356,860

(22) Filed: Jan. 21, 2009

(30) Foreign Application Priority Data
Jul. 29, 2008 (TW) 097128756

(51) Int. Cl. H01J 1/63; C09K 11/06

(52) U.S. Cl. 313/504; 252/301.35

(57) ABSTRACT

The present invention discloses a photo-curable hole-transport material used in a polymer light-emitting diode. The photo-curable hole-transport material comprises at least one first conjugate structure, at least one connecting structure, and at least one second conjugate structure. The first conjugate structure is a triarylamine derivative. The second conjugate structure is a carbazole derivative. The connecting structure is derived from one structure selected from the group consisting of the following or the combination thereof: urethane and urea structures.

### BACKGROUND OF THE INVENTION

1. Field of the Invention

The present invention is generally related to a hole-transport material, and more particularly to a hole-transport material used in a polymer light-emitting diode.

2. Description of the Prior Art

The principle of organic electroluminescence can be simply illustrated in the following. Under the external voltage, holes and electrons are separately injected into the anode and the cathode. The hole and the electron move toward each other under the effect of the electric field and recombine in the organic light-emitting material to become an exciton. The excitons release their energy in a form of light or heat when returning from the excited state to the ground state. The efficiency of an organic electroluminescence device depends on the effectiveness of luminescence by the radiative recombination of electrons and holes in the light-emitting layer. Most of the organic materials transport either electrons or holes and thus the excitons will be near either one of the two electrodes. If excitons are near the two electrodes, they will be quenched by metal. Exciton quenching is responsible for lowering the efficiency of the device. There are two improvement methods: one is to directly modify the structure of the organic molecule to have functional groups with both electron-transport and hole-transport properties; and the other one is to utilize a multi-layer structure in assisting balanced electron-injection and hole-injection into the organic layer.

Generally, a common multi-layer structure comprises a hole-transport layer (HTL) and a hole-injecting layer (HIL) between the light-emitting layer and the ITO anode and comprises an electron transport layer (ETL) and an electron injecting layer (EIL) between the light-emitting layer and the metallic cathode. The purpose of the multi-layer structure is to have injecting and transporting electrons and injecting and transporting holes be balanced so as to increase the recombination efficiency of electrons and holes in the light-emitting layer. Therefore, the maximum brightness intensity and quantum efficiency can be achieved. The electron transport layer and the hole transport layer are used to adjust electron mobility and hole mobility to have the two mobility be similar.

There are several key points in designing and synthesizing the above electron or hole transport material. Firstly, heat resistance and stability have to be high. Secondly, the energy barrier at the interface between the hole transport layer and the anode or between the electron transport layer and the cathode should be reduced because it was reported that the organic electroluminescence device has a longer lifetime as the energy barrier is smaller. Thirdly, the thin-film form can be naturally well formed because the thin-film layer of the organic electron or hole transport material may have the aging phenomenon due to re-crystallization after using for a long period of time. The aging phenomenon is the main cause to have the device gradually darkened after the device is turned on. Therefore, it is still necessary to research a novel electron- or hole-transport material to develop new materials having high heat resistance, high heat stability, low interface energy barrier, and low turn-on voltage to thereby increase the lifetime of the organic electroluminescence device and improve the brightness intensity and quantum efficiency.

### SUMMARY OF THE INVENTION

In light of the above background, in order to meet the requirement of the industry, the present invention provides a hole-transport material.

One characteristic of the present invention is to provide a photo-curable hole-transport material, comprising at least one first conjugate structure, at least one connecting structure, and at least one second conjugate structure. The first conjugate structure is a triarylamine derivative. The second conjugate structure is a carbazole derivative. The connecting structure is derived from one structure selected from the group consisting of the following or the combination thereof: urethane and urea structures.

Another characteristic of the present invention is to provide a polymer light-emitting diode. The structure of the polymer light emitting diode has the following laminating order from top to bottom: an anode, a hole-transport layer, a light-emitting layer, and a cathode. The hole-transport layer comprises a polyurethane derivative. The polyurethane derivative is a photo-curable material and further comprises a conjugate structure and a connecting structure. The connecting structure is derived from one structure selected from the group consisting of the following or the combination thereof: urethane and urea structures.

The invention utilizes a triarylamine-containing polyurethane derivative to prepare a polymer light-emitting diode having high efficiency. The optimized maximum brightness of the polymer light-emitting diode according to the invention is as high as 14,000 (cd/m²)/26 (eV) and the current efficiency reaches 34.7 (cd/A)/17 (eV), that are both higher than the polymer light-emitting diode in the prior art.

### BRIEF DESCRIPTION OF THE DRAWINGS

FIG. 1 is a flow chart illustrating the schemes of TPA and Cz synthesis reactions;

FIG. 2 is a flow chart illustrating the PU polymer synthesis of P1-P5;

FIG. 3 is a voltage-brightness characteristic chart of System (1);

FIG. 4 is a voltage-current efficiency characteristic chart of System (1);

FIG. 5 is a voltage-brightness characteristic chart of System (2); and

FIG. 6 is a voltage-current efficiency characteristic chart of System (2).

### DESCRIPTION OF THE PREFERRED EMBODIMENTS

What is probed into the invention is a hole-transport material. Detail descriptions of the structure and elements will be provided in the following in order to make the invention thoroughly understood. Obviously, the application of the invention is not confined to specific details familiar to those who are skilled in the art. On the other hand, the common structures and elements that are known to everyone are not described in details to avoid unnecessary limits of the invention. Some preferred embodiments of the present invention will now be described in greater detail in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

A first embodiment of the present invention discloses a hole-transport material used in a polymer light-emitting diode and also discloses a polymer light-emitting diode. The hole-transport material is photo-curable and comprises at least one first conjugate structure, at least one connecting structure, and at least one second conjugate structure. The first conjugate structure is a triarylamine derivative. The second conjugate structure is a carbazole derivative. The connecting structure is derived from one structure selected from the group consisting of the following or the combination thereof: urethane and urea structures. The polymer light emitting diode comprises an anode, a hole-transport layer provided on the anode, a light-emitting layer provided on the hole-transport layer and a cathode provided on the light-emitting layer.

The first conjugate structure has the following general equation:

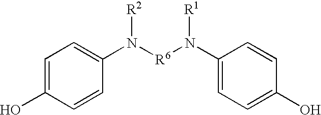

where R¹ and R² moieties can be the same or different and comprise one moiety selected from the group consisting of the following or the combination thereof:

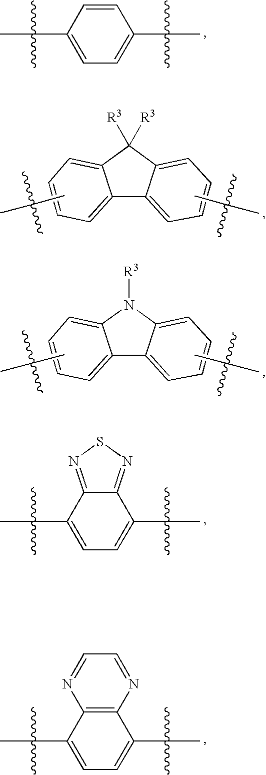

and H; where R³ is selected from the group consisting of the following: —(CH₂)ₓR⁴ and

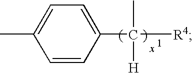

x¹ is 0˜25; R⁴ is selected from the group consisting of the following: H, —CH═CH₂, —OOC—CH═CH₂,

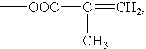

and

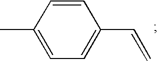

R⁶ is selected from the group consisting of the following:

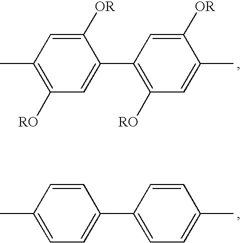

and

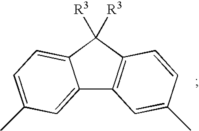

R is selected from the group consisting of the following: C1-C6 linear-chained alkyl moiety, —CH═CH₂, —OOC—CH═CH₂,

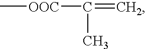

and

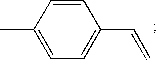

R³ is selected from the group consisting of the following: —(CH₂)ₓ—R⁴ and

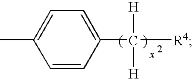

x² is 0˜25; R⁴ is selected from the group consisting of the following: H, —CH═CH₂, —OOC—CH═CH₂,

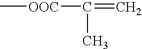

and

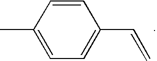

Furthermore, the preferred first conjugate structure has the following general equation:

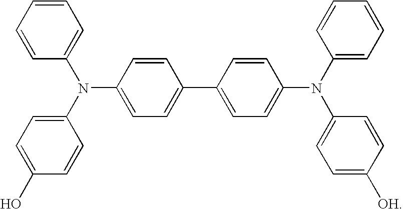

On the other hand, the second conjugate structure has the following general equation:

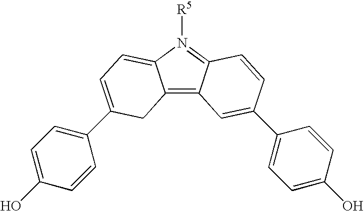

where R⁵ moiety is a C4-C16 linear-chained alkyl moiety or an aryl ring moiety, the aryl ring moiety is selected from the group consisting of the following or the combination thereof:

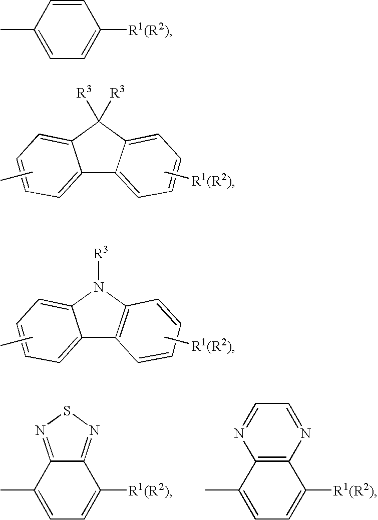

and H; R¹ and R² moieties can be the same or different and each comprise one selected from the group consisting of the following or the combination thereof:

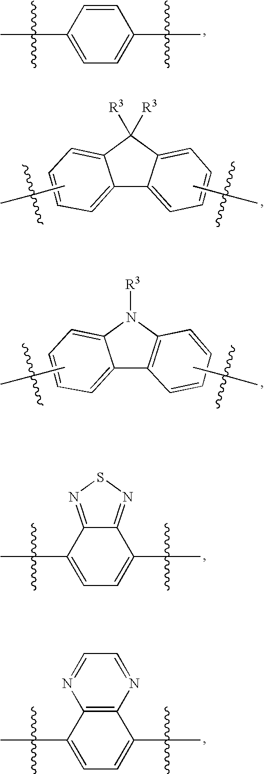

and H; R³ is selected from the group consisting of the following: —(CH₂)ₓ—R⁴ and

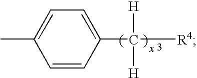

x³ is 0˜25; and R⁴ is selected from the group consisting of the following: H, —CH═CH₂, —OOC—CH═CH₂,

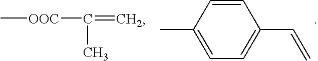

Moreover, the preferred second conjugate structure has the following general equation:

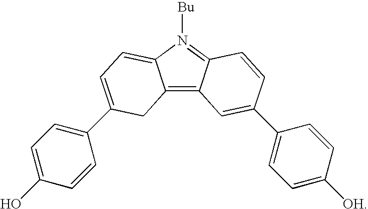

The material of the hole-transport layer has the following general equation:

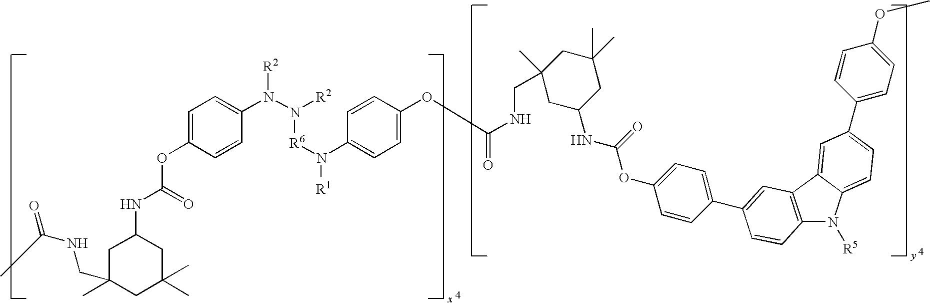

where X⁴ and y⁴ are integers and X⁴, y⁴≠0;
R¹ and R² moieties can be the same or different and comprise one moiety selected from the group consisting of the following or the combination thereof:

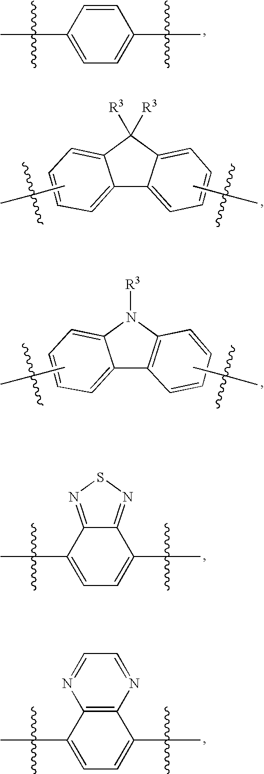

H; R³ is selected from the group consisting of the following: —(CH₂)ₓ—R⁴ and

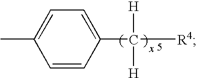

x⁵ is 0˜25; and R⁴ is selected from the group consisting of the following: H, —CH═CH₂, —OOC—CH═CH₂,

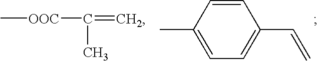

R⁵ moiety is a C4-C16 linear-chained alkyl moiety or an aryl ring moiety, the aryl ring moiety is selected from the group consisting of the following or the combination thereof:

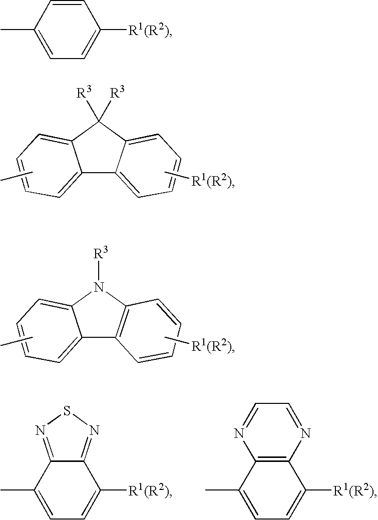

and H; R¹ and R² moieties can be the same or different and comprise one moiety selected from the group consisting of the following or the combination thereof:

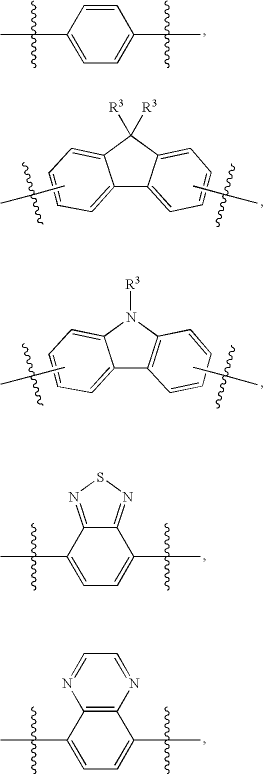

and H; R³ is selected from the group consisting of the following: —(CH₂)ₓ—R⁴,

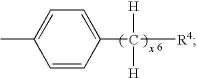

x⁶ is 0˜25; and R⁴ is selected from the group consisting of the following: H, —CH═CH₂, —OOC—CH═CH₂,

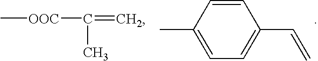

In a preferred example of this embodiment, the hole-transport material has a preferred general equation:

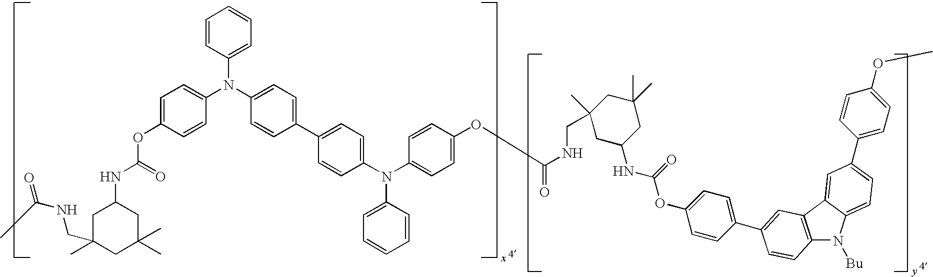

where x^{4′} and y^{4′} are integers and x^{4′}, y^{4′}≠0.

A second embodiment of the invention discloses a polymer light-emitting diode where the structure of the polymer light-emitting diode has the following top-to-bottom laminating order: an anode, a hole-transport layer, a light-emitting layer, and a cathode.

The hole-transport layer comprises a polyurethane derivative. The polyurethane derivative comprises a conjugate structure and a connecting structure. The conjugate structure is a triarylamine derivative. The connecting structure is derived from one structure selected from the group consisting of the following or the combination thereof: urethane and urea structures.

Furthermore, the preferred conjugate structure is as follows:

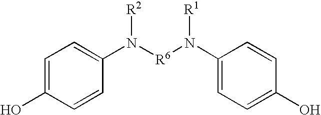

where R¹ and R² moieties can be the same or different and comprise one moiety selected from the group consisting of the following or the combination thereof:

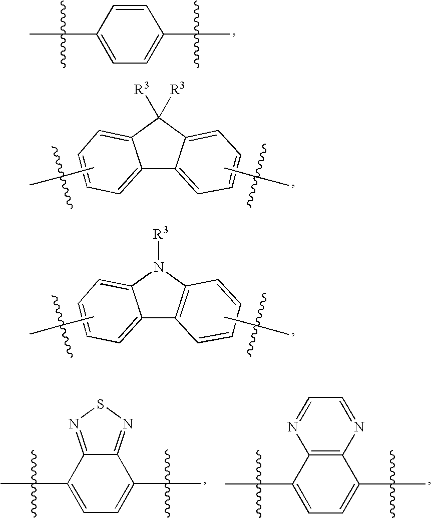

and H; where R³ is selected from the group consisting of the following: —(CH₂)ₓ—R⁴— and

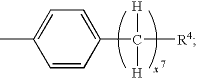

x⁷ is 0-25; R⁴ is selected from the group consisting of the following: H, —CH═CH₂, —OOC—CH═CH₂,

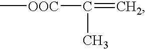

and

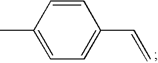

R⁶ is selected from the group consisting of the following:

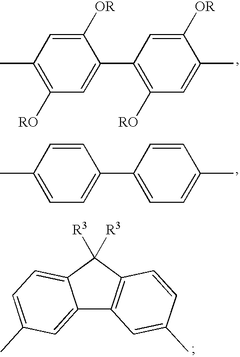

and R is selected from the group consisting of the following: C1-C6 linear-chained alkyl moiety, —CH═CH₂, —OOC—CH═CH₂,

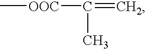

and

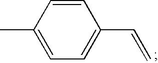

R³ is selected from the group consisting of the following: —(CH₂)ₓ—R⁴ and

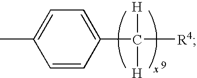

x⁹ is 0˜25; R⁴ is selected from the group consisting of the following: H, —CH═CH₂, —OOC—CH═CH₂,

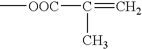

and

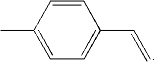

Furthermore, the conjugate structure has a preferred general equation:

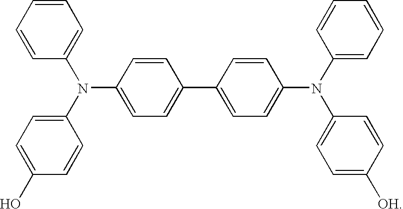

In a preferred example of this embodiment, the polyurethane derivative has the following general equation:

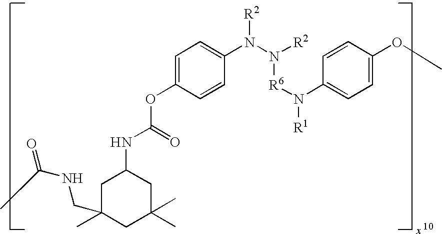

where x¹⁰ is an integer;
R¹ and R² moieties can be the same or different and comprise one moiety selected from the group consisting of the following or the combination thereof:

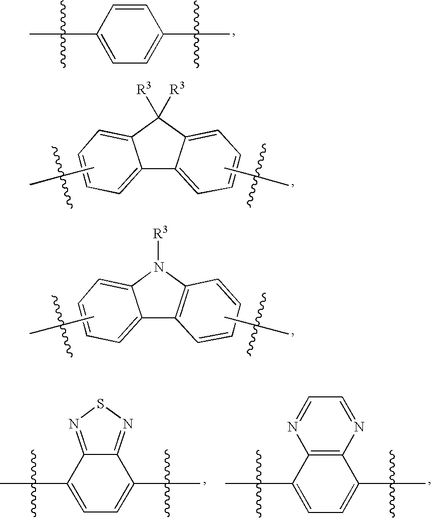

and H; where R³ is selected from the group consisting of the following: —(CH₂)ₓR⁴ and

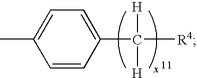

x¹¹ is 0˜25; R⁴ is selected from the group consisting of the following: H, —CH═CH₂, —OOC—CH═CH₂,

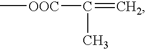

and

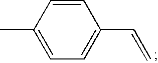

R⁶ is selected from the group consisting of the following:

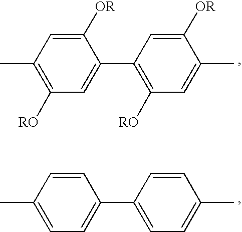

and

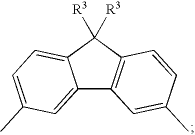

R is selected from the group consisting of the following: C1-C6 linear-chained alkyl moiety, —CH═CH₂, —OOC—CH═CH₂,

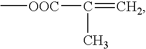

and

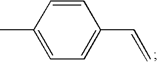

R³ is selected from the group consisting of the following: —(CH₂)ₓ—R⁴ and

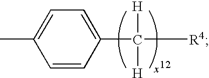

x¹² is 0-25; R⁴ is selected from the group consisting of the following: H, —CH═CH₂, —OOC—CH═CH₂,

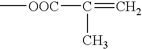

and

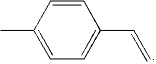

In a more preferred example of this embodiment, the polyurethane derivative has the following general equation:

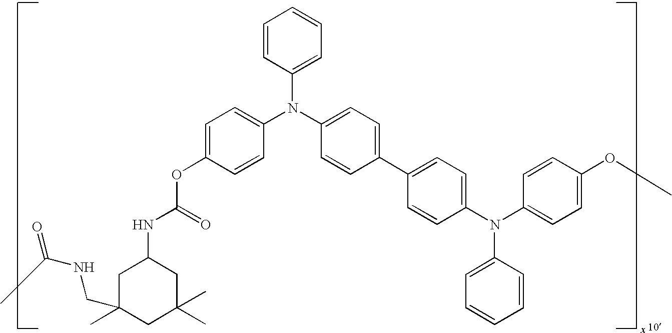

where x^{10′} is an integer.

A third embodiment of the invention discloses a polymer light-emitting diode where the structure of the polymer light-emitting diode has the following top-to-bottom laminating order: an anode, a first hole-transport layer, a second hole-transport layer, a light-emitting layer, and a cathode.

The first hole-transport layer comprises at least one hole-transport material. The least one hole-transport material is polyethylene dioxythiophene doped with polystyrene-sulfonic acid (PEDOT-PSS).

The second hole-transport layer comprises a polyurethane derivative. The polyurethane derivative comprises a conjugate structure and a connecting structure. The conjugate structure is a carbazole derivative and the connecting structure is derived from one structure selected from the group consisting of the following or the combination thereof: urethane and urea structures.

Moreover, the preferred conjugate structure is as follows:

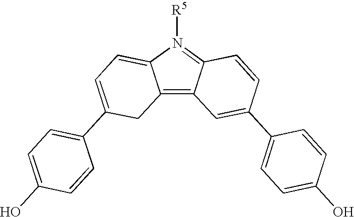

where R⁵ moiety is a C4-C16 linear-chained alkyl moiety or an aryl ring moiety, the aryl ring moiety is selected from the group consisting of the following or the combination thereof:

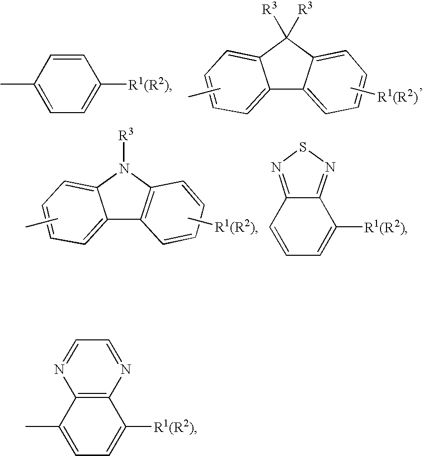

and H; where R¹ and R² moieties can be the same or different and each comprise one selected from the group consisting of the following or the combination thereof:

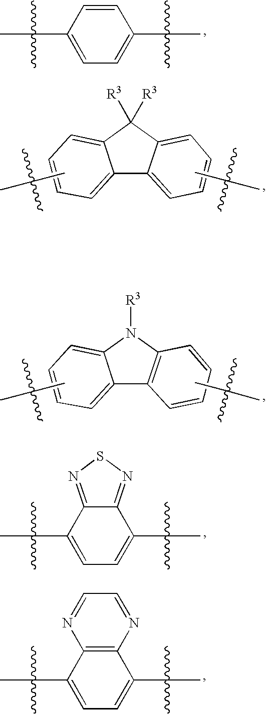

and H; R³ is selected from the group consisting of the following: —(CH₂)ₓ—R⁴ and

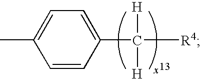

x¹³ is 0˜25; and R⁴ is selected from the group consisting of the following: H, —CH═CH₂, —OOC—CH═CH₂,

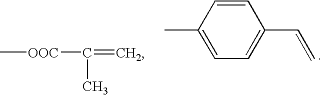

In a preferred example of this embodiment, the polyurethane derivative has the following general equation:

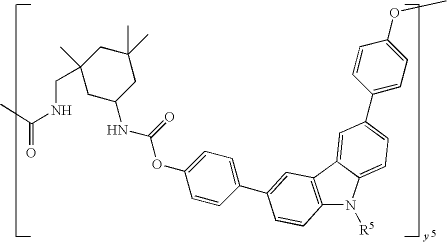

where y⁵ is an integer;
R⁵ moiety is a C4-C16 linear-chained alkyl moiety or an aryl ring moiety, the aryl ring moiety is selected from the group consisting of the following or the combination thereof:

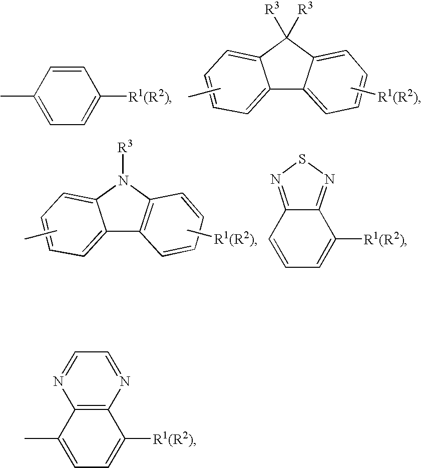

and H; where R¹ and R² moieties can be the same or different and each comprise one selected from the group consisting of the following or the combination thereof:

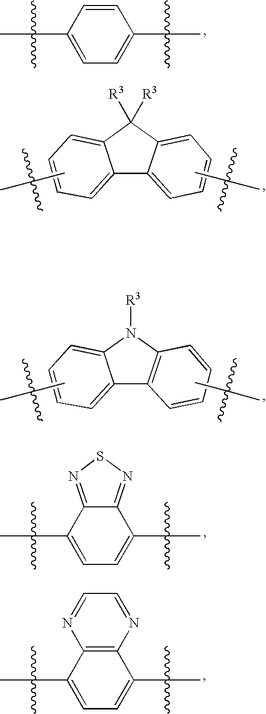

and H; R³ is selected from the group consisting of the following: —(CH₂)ₓ—R⁴ and

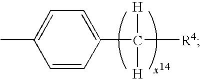

x¹⁴ is 0˜25; and R⁴ is selected from the group consisting of the following: H, —CH═CH₂, —OOC—CH═CH₂,

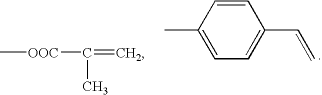

In a more preferred example of this embodiment, the polyurethane derivative has the following general equation:

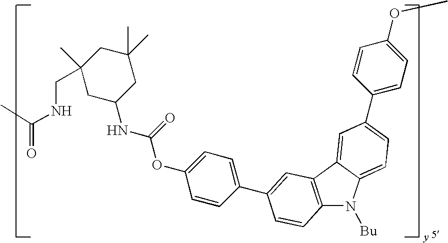

where y^{5′} is an integer.

### Example 1

### Synthesis of Polyurethane Derivative

The polyurethane derivative has a general equation of TPA-IPDI-Cz where IPDI is urethane that connects TPA (triphenylamine derivative) and Cz (carbazole derivative). TPA is a good hole-injecting material while Cz is a good hole-transport material. The structure of IPDI is as follows:

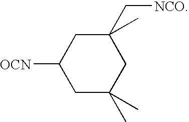

(i) Synthesis of TPA (Triphenylamine Derivative)

At 190° C., N,N″-diphenylbenzidine and 4-iodoanisole are mixed and dissolved in 1,2-dichlorobenzene to react for 36 hours. The compound N,N″-bis(4-methoxyphenyl)-N,N″-diphenylbenzidine (1) is obtained. Then, the compound (1) and BBr₃ are dissolved in CH₂Cl₂ to react for 2 hours at −78° C. The triphenylamine derivative (2) is thus obtained and has the structure as follows:

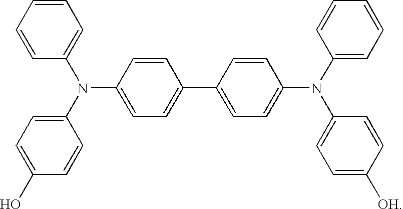

(ii) synthesis of Cz (Carbazole Derivative)

9H-Carbazole reacts with NBS under ice bath to form 3,6-dibromo-9H-carbazole (3). Then, the compound (3) reacts with 1-bromobutane and a phase transition reagent is also added. Thus, 3,6-dibromo-9-butylcarbazole (4) is obtained. The Suzuki coupling reaction between the compound (4) and 4-MeOC₆H₄B(OH)₂ are taken placed to form 9-butyl-3,6-bis(4-methoxyphenyl)carbazole (5). Finally, BBr₃ is used to remove the methoxy moiety of the compound (5) to obtain the product (6) having the structure as follows:

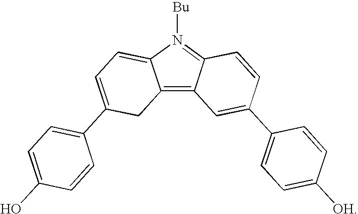

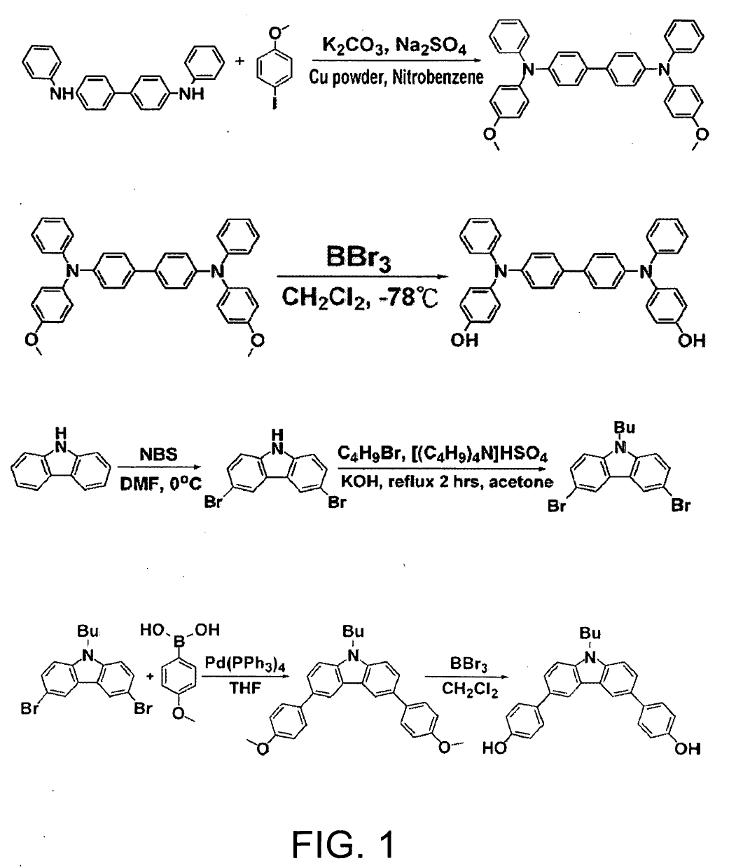

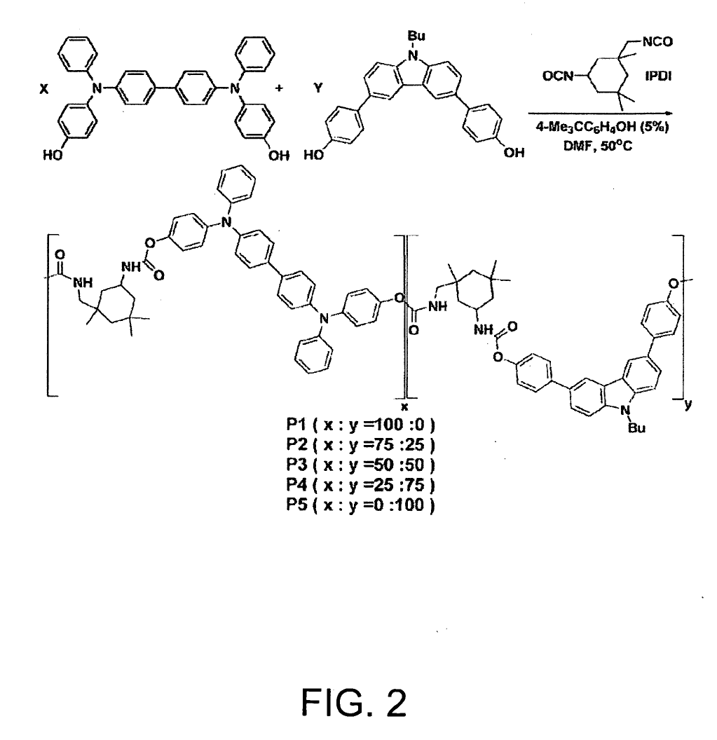

The flow chart of the synthesis reaction is shown in FIG. 1. IPDI is a connecting unit and the polymerization of the compounds (2) and (6) is performed to obtain the PU copolymers P2-P4. The reacting ratio of TPA to Cz is 3:1, 1:1, 1:3 for the copolymers P2-P4, respectively. P1 (X=1) and P5 (Y=1) are PU homopolymers of pure TPA and Cz, respectively. The flow chart of synthesizing the PU polymers P1-P5 is shown in FIG. 2.

### Example 2

### Polymer Light-Emitting Diode

System (1): ITO/PU/[Ir(ppy)₃+PVK+t-PBD]/Mg/Ag

The PU polymer (P1-P5) is spin-coated and forms a film on a substrate having an ITO anode. Then, [Ir(ppy)₃+PVK+t-PBD] is spin-coated on the surface of the PU film to form a photo-reacting layer. Finally, the cathode materials, Mg and Ag, are evaporated and deposited on the photo-reacting layer in vacuum. Thus, the polymer light-emitting diode of the system (1) is formed. The system (1) comprises six types (S1 and DP1-DP5) of polymer light-emitting diodes. S1 comprises no polyurethane derivative, that is ITO/PU (20 nm)/[Ir(ppy)3+t-PBD+PVK] (50 nm)/Mg (10 nm)/Ag (100 nm). The efficiency parameters of the system (1) are shown in Table 1.

TABLE 1

| | EL | | | |
|---|---|---|---|---|
| | emission | Turn-on voltage | Max. brightness | Efficiency |
| Device | λₘₐₓ/nm | at 100 cd m⁻²/eV | cd m⁻²/eV | (cd A⁻¹)/eV |
| DP1 | 513 | 14 | 14 000/26 | 13.4/22 |
| DP2 | 510 | 17 | 9970/26 | 5.5/18 |
| DP3 | 510 | 18 | 11 800/26 | 12.0/18 |
| DP4 | 510 | 14 | 9190/21 | 3.6/19 |
| DP5 | 513 | 17 | 9240/23 | 6.4/23 |
| S1 | 508 | 31 | 296/37 | 1.1/32 |

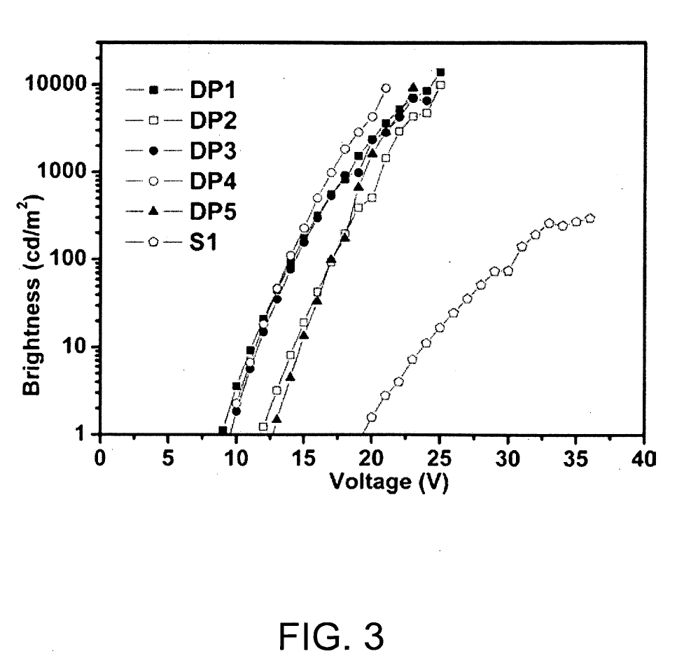

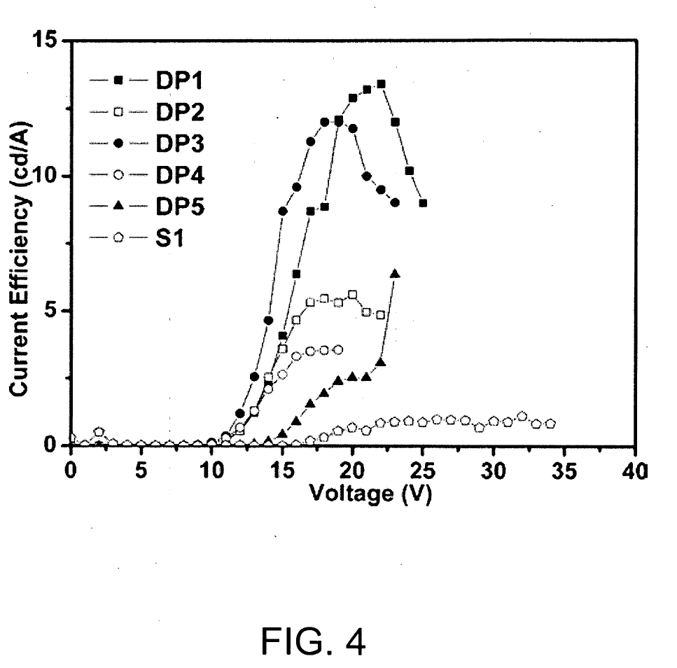

Referring to FIG. 3, the turn-on voltages, the maximum brightness, the maximum efficiency of DP1-DP5, compared to S1, are obviously improved. Among the above, DP1 has the best maximum brightness of 14,000 (cd/m²)/26 (eV). In addition, the voltage-current efficiency characteristic chart for DP1-DP5 and S1 is shown in FIG. 4.

System (2): ITO/PEDOT/PU/[Ir(ppy)3+PVK+t-PBD]/Mg/Ag

At first, the common hole-transport material is formed a film on a substrate having an ITO anode. Then, the polyurethane derivative and [Ir(ppy)3+PVK+t-PBD] are separately spin-coated and form films. Finally, the cathode materials, Mg and Ag, are deposited on the device. Thus, the polymer light-emitting diode of the system (2) is formed. The system (2) comprises six types (S2 and DDP1-DDP5) of polymer light-emitting diodes. S2 comprises no polyurethane derivative, that is ITO/PEDOT-PSS (30 nm)/[Ir(ppy)₃+t-PBD+PVK] (50 nm)/Mg (10 nm)/Ag (100 nm). The efficiency parameters of the system (2) are shown in Table 2.

TABLE 2

| | EL | | | |
|---|---|---|---|---|
| | emission | Turn-on voltage | Max. brightness | Efficiency |
| Device | λₘₐₓ/nm | at 100 cd m⁻²/eV | cd m⁻²/eV | (cd A⁻¹)/eV |
| DDP1 | 511 | 11 | 12 500/22 | 29.4/16 |
| DDP2 | 506 | 13 | 12 100/25 | 19.6/15 |
| DDP3 | 507 | 14 | 9900/24 | 17.1/15 |
| DDP4 | 509 | 14 | 10 500/23 | 21.0/15 |
| DDP5 | 509 | 13 | 8280/24 | 34.7/17 |
| S2 | 508 | 12 | 6250/22 | 21.8/15 |

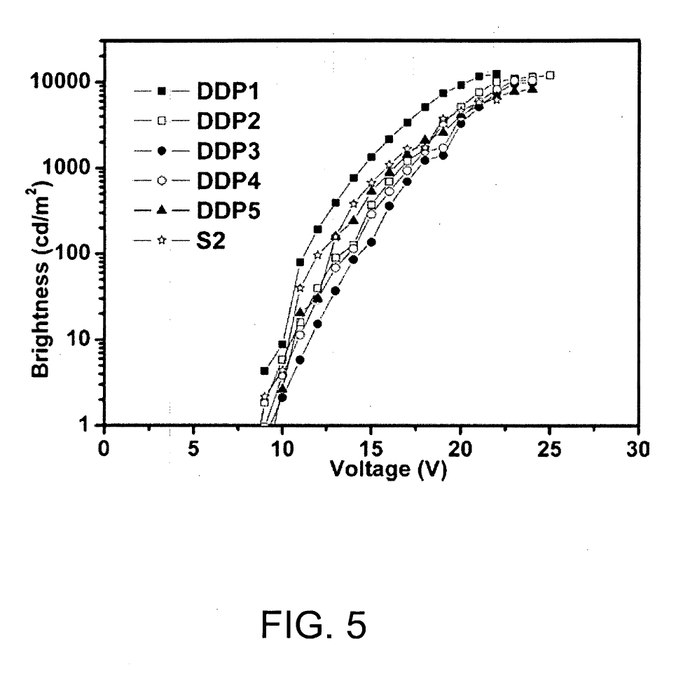

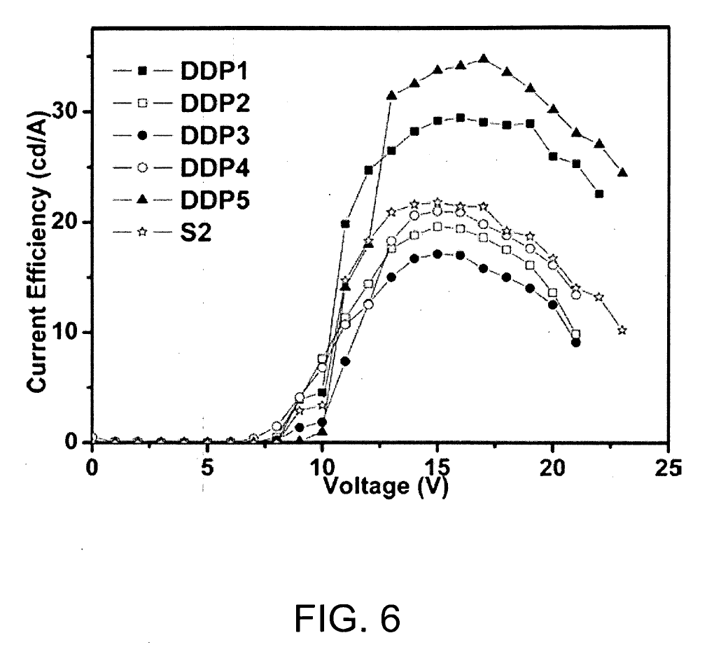

Referring to FIG. 5, the turn-on voltages, the maximum brightness, the maximum efficiency of DDP1-DDP5, compared to S2, are obviously improved. In addition, the voltage-current efficiency characteristic chart for DDP1-DDP5 and S2 is shown in FIG. 6. Among the above, DDP5 has the best current efficiency of 34.7 (cd/A)/17 (eV).

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. A hole transport material for a polymer light emitting diode, the material comprising:
at least one first conjugate structure;
at least one connecting structure; and
at least one second conjugate structure;
wherein the first conjugate structure is a triarylamine derivative; the connecting structure is derived from one selected from the group consisting of the following or the combination thereof: urethane and urea structures; the second conjugate structure is a carbazole derivative; and besides the polymer light emitting diode comprises an anode, a hole-transport layer provided on the anode, a light-emitting layer provided on the hole-transport layer and a cathode provided on the light-emitting layer.

2. The material according to claim 1, wherein the first conjugate structure has the following general equation: 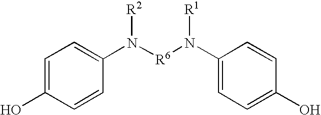
where R¹ and R² moieties can be the same or different and comprise one moiety selected from the group consisting of the following or the combination thereof: 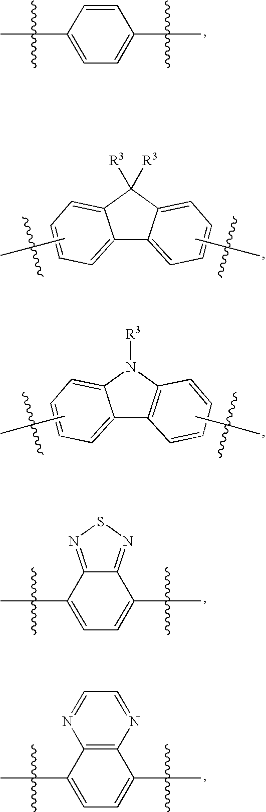
and H;
where R³ is selected from the group consisting of the following:
—(CH₂)ₓR⁴ and 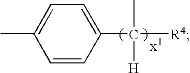
x¹ is 0˜25;
R⁴ is selected from the group consisting of the following:
H, —CH═CH₂, —OOC—CH═CH₂, 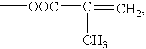
and 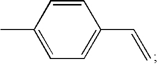
R⁶ is selected from the group consisting of the following: 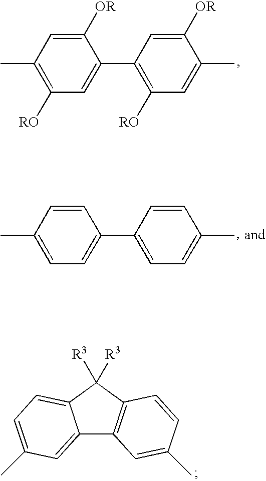
R is selected from the group consisting of the following: C1-C6 linear-chained alkyl moiety, —CH═CH₂, —OOC—CH═CH₂, 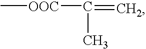
and 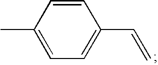
R³ is selected from the group consisting of the following:
—(CH₂)ₓ—R⁴ and 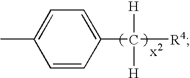
x² is 0˜25;
R⁴ is selected from the group consisting of the following:
H, —CH═CH₂, —OOC—CH═CH₂, 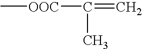
and

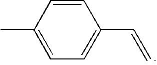

3. The material according to claim 1, wherein the second conjugate structure has the following general equation: 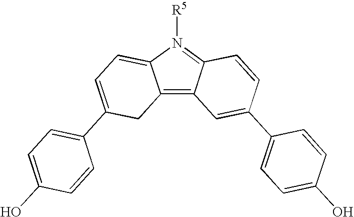
where R⁵ moiety is a C4-C16 linear-chained alkyl moiety or an aryl ring moiety, the aryl ring moiety is selected from the group consisting of the following or the combination thereof: 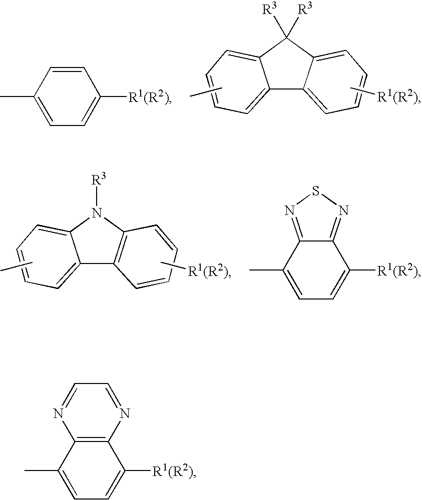
and H;
R¹ and R² moieties can be the same or different and each comprise one selected from the group consisting of the following or the combination thereof: 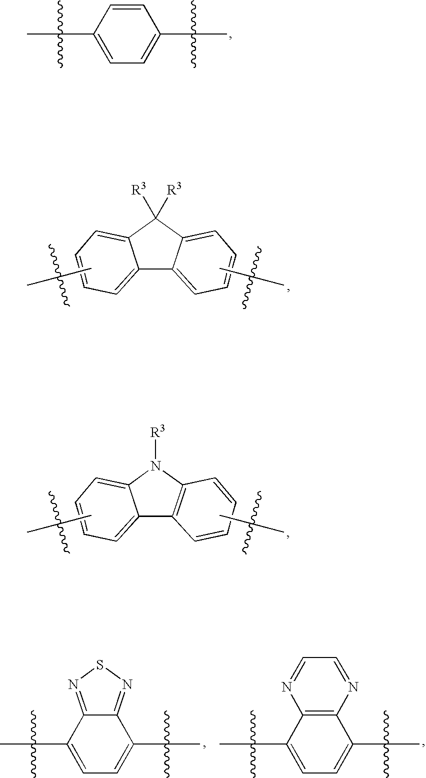
and H;
R³ is selected from the group consisting of the following:
—(CH₂)ₓ—R⁴ and 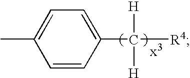
x is 0˜25; and
R⁴ is selected from the group consisting of the following: H, —CH═CH₂, —OOC—CH═CH₂,

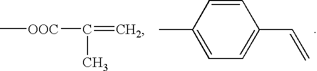

4. The material according to claim 1, wherein the material of the hole-transport layer has the following general equation: 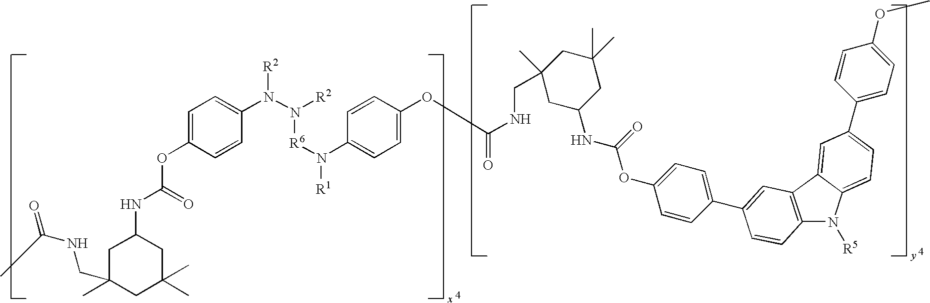
where x⁴ and y⁴ are integers and x⁴, y⁴#0;
R¹ and R² moieties can be the same or different and comprise one moiety selected from the group consisting of the following or the combination thereof: 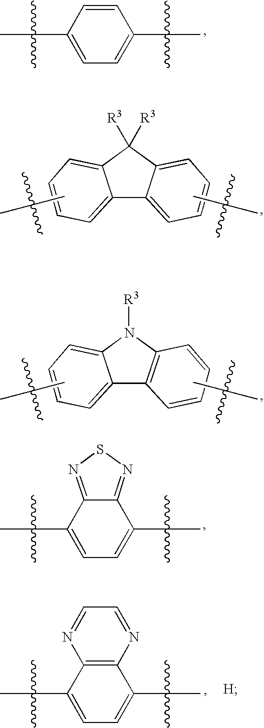
R³ is selected from the group consisting of the following: —(CH₂)ₓ—R⁴ and 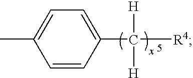
X⁵ is 0˜25; and
R⁴ is selected from the group consisting of the following: H, —CH═CH₂, —OOC—CH═CH₂, 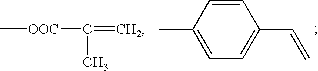
R⁶ is selected from the group consisting of the following: 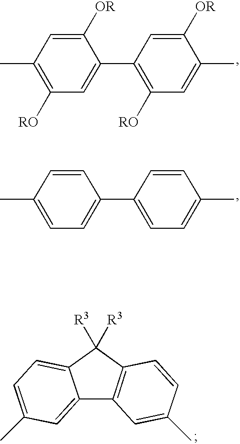
R is selected from the group consisting of the following: C1-C6 linear-chained alkyl moiety, —CH═CH₂, —OOC—CH═CH₂, 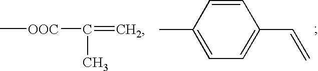
R³ is selected from the group consisting of the following:
—(CH₂)ₓ—R⁴, 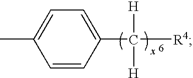
x⁶ is 0˜25;
R⁴ is selected from the group consisting of the following:
H, —CH═CH₂, —OOC—CH═CH₂, 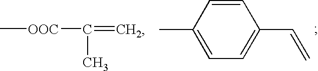
R⁵ moiety is a C4-C16 linear-chained alkyl moiety or an aryl ring moiety, the aryl ring moiety is selected from the group consisting of the following or the combination thereof: 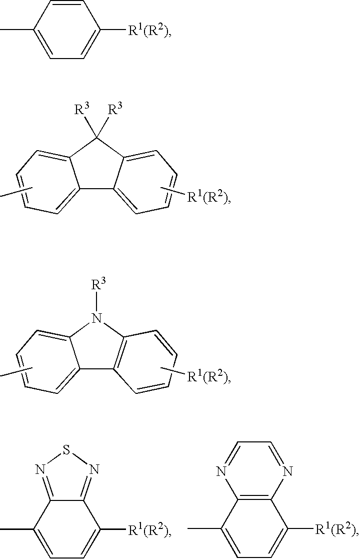
R¹ and R² moieties can be the same or different and comprise one selected from the group consisting of the following or the combination thereof: 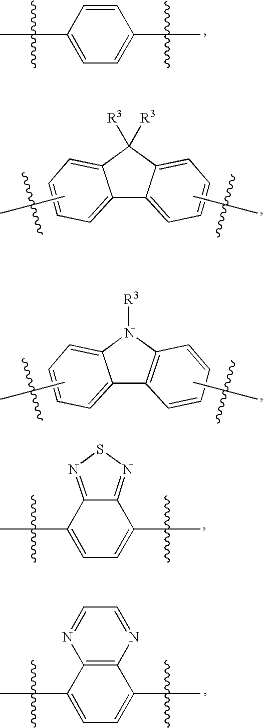
and H;
R³ is selected from the group consisting of the following:
—(CH₂)ₓ—R⁴, 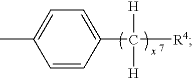
x⁷ is 0˜25; and
R⁴ is selected from the group consisting of the following: H, —CH═CH₂, —OOC—CH═CH₂,

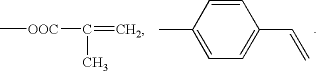

5. The material according to claim 1, wherein the material of the hole-transport layer is photo-curable.

6. A polymer light-emitting diode, comprising:
an anode;
a hole-transport layer, provided on the anode, comprising a polyurethane derivative having a conjugate structure and a connecting structure wherein the conjugate structure is a triarylamine derivative and the connecting structure is derived from one structure selected from the group consisting of the following or the combination thereof: urethane and urea structures;
a light-emitting layer provided on the hole-transport layer; and
a cathode provided on the light-emitting layer.

7. The polymer light-emitting diode according to claim 6, wherein the triarylamine derivative has the following general equation: 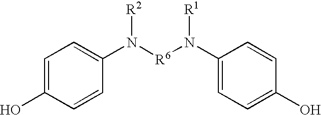
where R¹ and R² moieties can be the same or different and comprise one moiety selected from the group consisting of the following or the combination thereof: 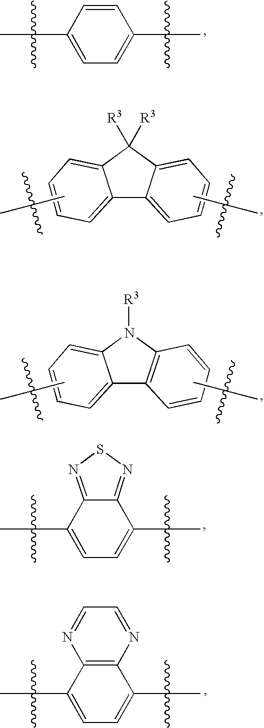
and H;
where R³ is selected from the group consisting of the following:
—(CH₂)ₓR⁴ and 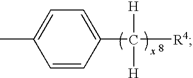
x⁸ is 0˜25;
R⁴ is selected from the group consisting of the following:
H, —CH═CH₂, —OOC—CH═CH₂, 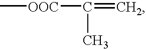
and 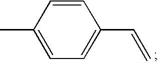
R⁶ is selected from the group consisting of the following: 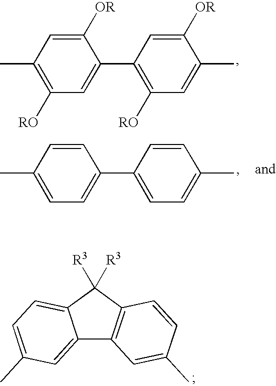
R is selected from the group consisting of the following: C1-C6 linear-chained alkyl moiety, —CH═CH₂, —OOC—CH═CH₂, 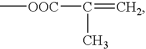
and 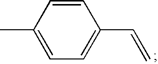
R³ is selected from the group consisting of the following:
—(CH₂)ₓ—R⁴ and 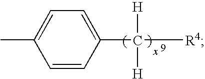
x⁹ is 0˜25;
R⁴ is selected from the group consisting of the following:
H, —CH═CH₂, —OOC—CH═CH₂, 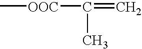
and

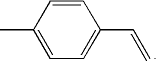

8. The polymer light-emitting diode according to claim 6, wherein the polyurethane derivative has the following general equation: 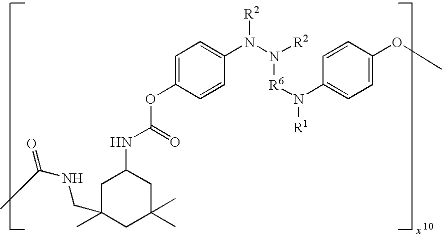
where X¹⁰ is an integer;
R¹ and R² moieties can be the same or different and comprise one moiety selected from the group consisting of the following or the combination thereof: 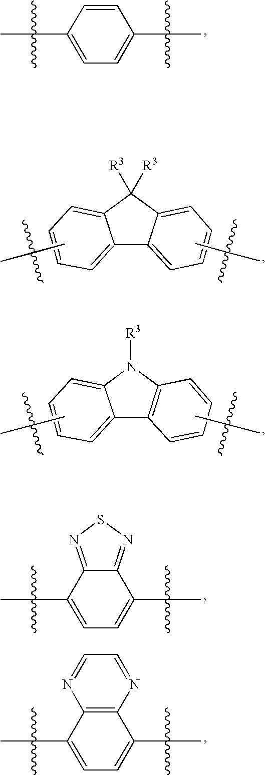
and H;
R³ is selected from the group consisting of the following: —(CH₂)ₓR⁴ and 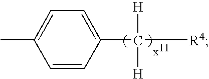
x¹¹ is 0˜25;
R⁴ is selected from the group consisting of the following:
H, —CH═CH₂, —OOC—CH═CH₂, 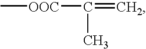
and 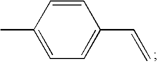
R⁶ is selected from the group consisting of the following: 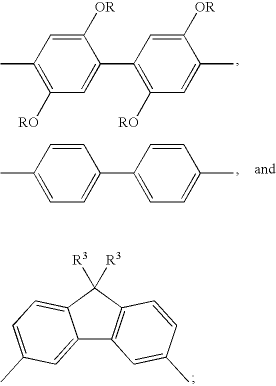
R is selected from the group consisting of the following: C1-C6linear-chained alkyl moiety, —CH═CH₂, —OOC—CH═CH₂, 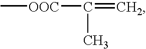
and 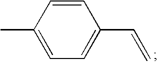
R³ is selected from the group consisting of the following:
—(CH₂)ₓ—R⁴ and 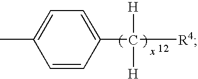
x¹² is 0˜25;
R⁴ is selected from the group consisting of the following:
H, —CH═CH₂, —OOC—CH═CH₂, 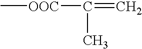
and

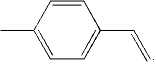

9. The polymer light-emitting diode according to claim 6, wherein the polyurethane derivative is photo-curable.

10. A polymer light-emitting diode, comprising:
an anode;
a first hole-transport layer, provided on the anode, comprising at least one hole-transport material;
a second hole-transport layer, provided on the first hole-transport layer, comprising a polyurethane derivative having a conjugate structure and a connecting structure wherein the conjugate structure is a carbazole derivative and the connecting structure is derived from one structure selected from the group consisting of the following or the combination thereof: urethane and urea structures;
a light-emitting layer; and
a cathode provided on the light-emitting layer layer.

11. The polymer light-emitting diode according to claim 10, wherein the hole-transport material is polyethylene dioxythiophene doped with polystyrene-sulfonic acid (PEDOT-PSS).

12. The polymer light-emitting diode according to claim 10, wherein the conjugate structure has the following general equation: 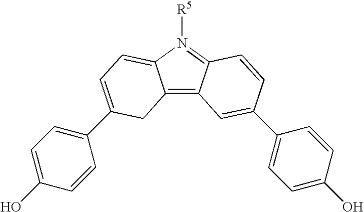
where R⁵ moiety is a C4-C16 linear-chained alkyl moiety or an aryl ring moiety, the aryl ring moiety is selected from the group consisting of the following or the combination thereof: 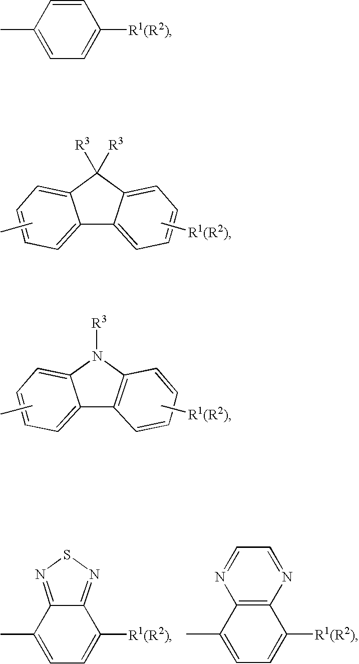
and H;
R¹ and R² moieties can be the same or different and each comprise one selected from the group consisting of the following or the combination thereof: 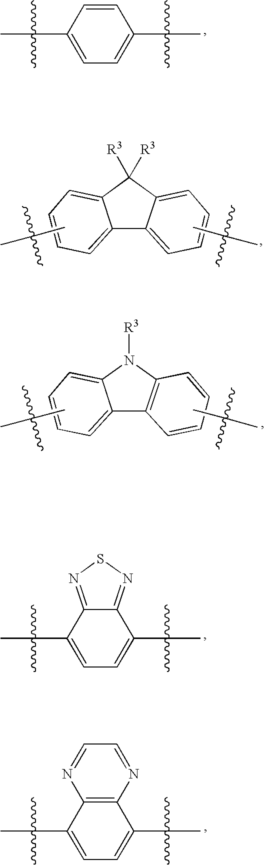
and H;
R³ is selected from the group consisting of the following:
—(CH₂)ₓ—R⁴ and 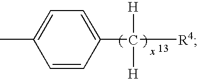
x¹³ is 0˜25; and
R⁴ is selected from the group consisting of the following: H, —CH═CH₂, —OOC—CH═CH₂,

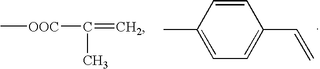

13. The polymer light-emitting diode according to claim 10, wherein the polyurethane derivative has the following general equation: 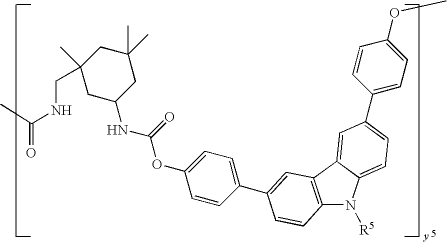
where y⁵ is an integer;
R⁵ moiety is a C4-C16 linear-chained alkyl moiety or an aryl ring moiety, the aryl ring moiety is selected from the group consisting of the following or the combination thereof: 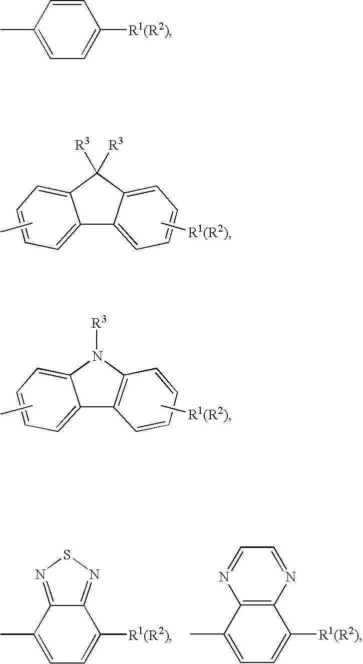
and H;
R¹ and R² moieties can be the same or different and each comprise one selected from the group consisting of the following or the combination thereof: 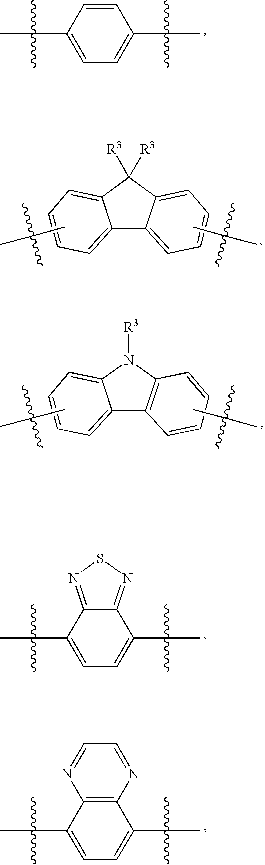
and H;
R³ is selected from the group consisting of the following:
—(CH₂)ₙ—R⁴ and 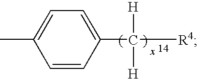
x¹⁴ is 0˜25; and
is selected from the group consisting of the following: H, —CH═CH₂, —OOC—CH═CH₂, [chemical structure]
